(19) United States
(12) Patent Application Publication
(10) Pub. No.: US 2025/0002790 A1
(43) Pub. Date: Jan. 2, 2025

(54) HYDROCONVERSION OF A BIOMASS FEEDSTOCK TO HYDROCARBON FUELS IN A SLURRY PHASE CATALYST REACTOR

(71) Applicant: CHEVRON U.S.A. INC., San Ramon, CA (US)

(72) Inventors: Ramin ABHARI, Bixby, OK (US); Bo KOU, Albany, CA (US)

(21) Appl. No.: 18/759,458

(22) Filed: Jun. 28, 2024

Related U.S. Application Data
(60) Provisional application No. 63/510,651, filed on Jun. 28, 2023.

(51) Int. Cl. C10G 3/00

(52) U.S. Cl. CPC C10G 3/46; C10G 2300/1011; C10G 2300/4006; C10G 2300/4012; C10G 2300/4018; C10G 2300/70; C10G 2400/04; C10G 2400/08

(57) ABSTRACT

Methods and reactor systems for conversion of bio-oils into renewable diesel, jet fuel, and gasoline. Phosphorus and metals containing feedstock is subjected to hydrodeoxygenation in a reactor comprising a solid catalyst suspended in a heavy oil.

### CROSS REFERENCE TO RELATED APPLICATIONS

This application is related to and claims the benefit of priority of U.S. Provisional Patent Appl. Ser. No. 63/510,651, filed on Jun. 28, 2023, the disclosure of which is herein incorporated in its entirety.

### FIELD OF THE INVENTION

The present technology relates to biomass-based hydrocarbons, and more particularly, to hydrocarbon fuels. Specifically, the present invention relates to methods and reactor systems for conversion of bio-oils into renewable diesel, jet fuel, and gasoline.

### BACKGROUND OF THE INVENTION

Hydrodeoxygenation (HDO) of fats, oils, and greases (FOG) in fixed-bed reactor systems is a critical step in the renewable diesel production process. In this hydroconversion step, the 10 wt % or higher oxygen content of the FOG feedstock is removed as water and carbon oxides, transforming the fatty acids, fatty acid esters, and other oxygenates into hydrocarbons. FOG feedstocks that are considered most environmentally sustainable are byproducts of rendering and food processing industries such as inedible tallow and used cooking oils. Other such FOG feedstocks include byproducts of palm oil and bioethanol industries like palm oil mill effluent and distillers corn oil. Bio-oils from pyrolysis and hydrothermal liquefaction represent another class of sustainable feedstock for potential hydroconversion in HDO reactor systems.

However, these environmentally sustainable feeds tend to contain relatively high levels of contaminants such as phosphorus, silicon, and chlorine compounds, as well as various solubilized metals and polymers (e.g. polyethylene), that impact performance of conventional HDO reactor systems. Specifically, the cited contaminants tend to deposit on the catalyst bed leading to pressure drop increase and catalyst deactivation. This in turn translates to costly production interruption associated with shutdown, catalyst change, and restart.

The prior art teaches various pretreatment methods for reducing the concentration of the contaminants to improve HDO efficiency. However, these pretreatment methods are only partially effective and most contaminants remain in the pretreated feed to the HDO reactor. As such, in order to prevent HDO reactor shutdown due to catalyst deactivation and bed plugging, many sustainable feedstock are largely excluded or included at relatively low amounts in HDO feeds.

Our U.S. Pat. No. 8,231,804 describes hydrogenation/hydrogenolysis of naturally occurring fatty acids and esters for production of paraffin compositions comprising of at least 75 wt % even carbon number paraffins. In the disclosed method, the mainly C12-C18 paraffin product remains in the liquid phase and has to be separated from the reactor catalyst by filtration.

There thus remains an unmet need for HDO methods and systems that are suitable for hydroconversion of low-value and waste FOG feedstocks, and bio-oils in general, such that reactor operation is not interrupted by catalyst deactivation and reactor pressure drop increase.

### BRIEF DESCRIPTION OF THE SEVERAL VIEWS OF THE DRAWINGS

FIG. 1 is a schematic diagram of an embodiment of the present invention for hydroconversion of FOG feedstock.

### SUMMARY

FOG feedstock with phosphorus and metals content greater than 10 wppm is subjected to hydrodeoxygenation in a reactor comprising a solid catalyst suspended in a heavy oil. The solid catalyst is preferably a sulfided molybdenum catalyst having an equivalent particle diameter less than 800 micron, and the heavy oil is a hydrocarbon with an initial boiling point of about 650 F. The method includes the steps of (a) introducing a feedstock comprising FOG and a hydrogen-rich gas to the reactor at a rate to maintain a space velocity in the range of 0.2 to 10 h⁻¹ (vol/hr FOG per vol reactor), (b) maintaining the reactor at a temperature in the 600-750 F range and a pressure between 150 and 1,000 psig, such that most of the feedstock mass is converted to hydrocarbons that are in vapor phase at reactor conditions, (c) withdrawing the vapors and unreacted hydrogen from the reactor, and (d) condensing the hydrocarbon vapors. In embodiments, the catalyst slurry is withdrawn from the reactor for separation of catalyst and/or separation of unconverted FOG species and non-vaporized reaction products from the heavy oil and/or catalyst. In embodiments, the separation of the catalyst is performed by filtration. In embodiments, the separation of the unconverted FOG species and non-vaporized reaction products is conducted by solvent extraction. In embodiments, the condensed hydrocarbon vapors and/or the non-vaporized hydrocarbon product is used as a diesel, jet fuel, or gasoline blendstock. In embodiments, the HDO condensed hydrocarbon vapors and/or the non-vaporized hydrocarbon product is subjected to isomerization prior to fractionation into diesel, jet, and gasoline for use as blended or neat fuels.

### DETAILED DESCRIPTION OF THE INVENTION

The apparatuses and methods disclosed in this document are described in detail by way of examples and with reference to the figures. Unless otherwise specified, like numbers in the figures indicate references to the same, similar, or corresponding elements throughout the figures. It will be appreciated that modifications to disclosed and described examples, arrangements, configurations, components, elements, apparatuses, methods, materials, etc. can be made and may be desired for a specific application. In this disclosure, any identification of specific shapes, materials, techniques, arrangements, etc. are either related to a specific example presented or are merely a general description of such a shape, material, technique, arrangement, etc. Identifications of specific details or examples are not intended to be, and should not be, construed as mandatory or limiting unless specifically designated as such. Selected examples of apparatuses and methods are hereinafter disclosed and described in detail with reference made to FIGURES.

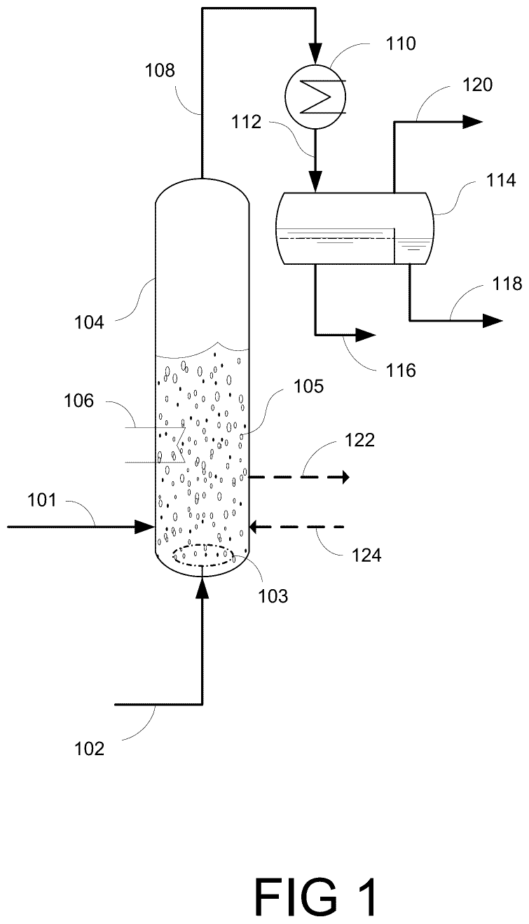

Referring to FIG. 1, a feed stream 101 comprising low-value and waste FOG is introduced to a slurry bubble column reactor (SBCR). The feed stream 101 comprises low-value animal fats such as Bleachable Fancy Tallow, Choice White Grease (CWG), and poultry oils. In embodiments, the lipid feedstock further comprises plant-based oils such as water-degummed Soybean Oil (SBO) and Palm Oil Mill Effluent (POME). In embodiments, the feed stream 101 further comprises greases from industrial food processing and restaurant operations such as Used Cooking Oil (UCO), Yellow Grease (YG), and Brown Grease (BG). Feed stream 101 comprises at least 10 wppm total phosphorus and metals. Depending on quality, UCO has chlorine levels in the 3 to 50 ppm range. Here, chlorine refers to the organochlorine and other chlorinated contaminants and adulterant present in the UCO as measured by test methods such as microcoulometry. In embodiments, the feed stream 101 may further comprise the residue from distillation of biodiesel or biodiesel bottoms, as described in U.S. Pat. No. 11,078,427. Biodiesel bottoms comprises undistilled biodiesel (methyl/ethyl fatty acid esters), as well as monoglycerides and at least 40% sterols and sterol esters. In embodiments, the feed stream 101 may further include bio-oils produced by pyrolysis or hydrothermal liquefaction (HTL) of lignocellulosic biomass as described in the prior art. US Patent Publication 2005/0167259 discloses a pyrolysis method for converting solid biomass to a bio-oil. US Patent Publication 2019/026300 describes a method for conducting HTL of mixed solid biomass and waste feedstock.

Furthermore, to maintain activity of the sulfided catalyst (described in a later paragraph herein) the feed stream 101 may include a sulfiding agent such as dimethyl disulfide at about 100-1000 ppm sulfur. The feed stream 101 is pressurized (preferably using a high-pressure metering pump) to enter SBCR 104. SBCR 104 is a vessel designed for intimate contacting of liquid, gas, and solid catalyst. A catalyst slurry 105 is dispersed via a hydrogen-rich gas 102 is introduced in the SBCR 104 through a gas sparger 103. The function of the gas sparger is to uniformly distribute the hydrogen gas as tiny bubbles in the liquid. The catalyst slurry 105 comprises 1-20% catalyst by weight suspended in a heavy oil.

The catalyst is molybdenum or tungsten sulfide, with an optional promoter. The promoter is a Group VIII (IUPAC Groups 8-10) metal present in the catalyst at relatively low levels for improving activity or stability. A preferred promoter for the tungsten or molybdenum catalyst is nickel or cobalt. In embodiments, the catalyst slurry 105 comprises 1-10 wt % molybdenum sulfide catalyst suspended in heavy oil. The heavy oil may be any hydrocarbon composition with an initial boiling point above 650 F. Preferred heavy oils comprise mainly of naphthenic and aromatic hydrocarbons. Suitable heavy oils for suspension of catalyst include heat transfer fluids such as PARARTHERM HT, vacuum gas oil (VGO), and FCC slurry oil. If the heavy oil is low in sulfur, a sulfiding agent such as dimethyl disulfide is added to the feed stream 101 at levels between 100 and 10,000 wppm sulfur to maintain catalyst in the active sulfide form.

The pressurized liquid stream 101 undergoes catalytic reactions with hydrogen in the SBCR 104. The hydrogen-rich gas 102 is optionally preheated. This preheat is used along with optional cooling coils 106 to maintain the reactor at a temperature in the 630-750 F range, preferably at 640-680 F. The hydrogen-rich gas 105 preferably has a hydrogen concentration between 70 and 100 mol %, preferably between 80 and 99 mol %. The hydrogen-rich gas 102 is supplied at a rate of about 3,000 to about 15,000 SCF/bbl (volume gas per volume of feed stream 101). The gas to feed ratio is preferably from about 4,000 SCF/bbl to about 8,000 SCF/bbl. The SBCR 104 operates at a pressure between 150 psig and 1,000 psig, preferably between 240 and 980 psig.

The diameter of the SBCR vessel 104 is selected such that the gas flow rate is in the churn-turbulent regime from about 7 cm/s to about 40 cm/s, preferably from about 8 cm/s to about 12 cm/s. The hydrogen-rich gas 102 is dispersed through a sparger 103. The sparger may be of various configurations including but not limited to a ring-type sparger with multiple orifices, a sintered metal plate or sintered metal distributing pipe(s) or co-fed with the feed stream 101 via a simple pipe distributor. In some embodiments the catalyst is dispersed in the slurry phase by mechanical agitation. The gas flow through the reactor 104 produces a uniform catalyst slurry 105. Alternatively, a side arm/downcomer (not shown) can also be deployed to recirculate de-gassed slurry to the reactor 104 which also aids catalyst distribution in the reactor 104. The feed stream 101 converts into hydrocarbons as it comes into intimate contact with catalyst and hydrogen in the catalyst slurry 105.

Specifically, the SBCR reaction converts the FOG fatty acid/glycerides to aliphatic hydrocarbons while generating water, CO, and CO2 as the main byproducts. When the feed stream 101 includes bio-oils from pyrolysis or HTL, aromatic and naphthenic hydrocarbons are also formed. At the preferred operating temperature, pressures, and gas-to-oil ratio described earlier herein, the hydrocarbon product composition is mainly in the vapor phase. The SBCR product is thus mainly carried out with the hydrogen-rich gas (comprising unreacted hydrogen) as SBCR vapor 108. The SBCR vapor 108 is cooled in condenser 110 to provide a three-phase fluid 112 comprising of hydrogen gas, CO, CO2, non-condensable vapor products (mainly propane), condensed hydrocarbon liquid product, and water. The three-phase fluid 112 is thus separated into a water byproduct 116, a condensed hydrocarbon product 118, and a gas/vapor 120. Since the condensed hydrocarbon product 118 comprises “waxy” octadecane, the condenser 110 is operated such that the cooling surfaces are at a temperature higher than the freezing point of octadecane (28 C or 82 F). For example, when a shell and tube exchanger is used as the condenser 110, the cooling water for the exchanger is preferably maintained at a temperature above 82 F. Various means of achieving condenser temperature control, including when the condenser 110 is an air cooler, are known to persons skilled in the art and may be adapted to the present technology as described herein.

The gas/vapor 120 may be processed through a scrubber to separate the CO2 (as well as the H2S and NH3 as minor byproducts) before optional recycle to the SBRC 104 along with the hydrogen-rich gas 102. Amine or caustic scrubbers may be used for this gas cleanup step. In embodiments, a portion or all the scrubbed gas is processed through an absorption column (using a hydrocarbon solvent as “sponge oil”) and/or a gas membrane to separate the propane from the scrubbed hydrogen-rich gas. The separated propane product is a fuel co-product of the present technology.

The condensed hydrocarbon product 118 is a mainly C11-C18 paraffinic distillate. Depending on type of bio-oil in feed stream 101, and the hydrocracking side reactions, various C5-C10 aromatic, naphthenic, and isoparaffinic hydrocarbons may also be present. The condensed hydrocarbon product 118 has an oxygen content of less than 0.1 wt % and a total acid number of less than 1 mg KOH/g. This distillate may be isomerized through an isomerization reactor as disclosed in the prior art (e.g. U.S. Pat. No. 5,135,638) to improve low temperature flow properties before fractionation into a diesel and gasoline, or optionally, diesel, jet fuel, and gasoline.

Returning to FIG. 1, and more particularly, to the SBCR 104, to maintain catalyst activity in the presence of relatively high concentrations of contaminants and potential catalyst poisons in feed stream 101, a catalyst slurry 122 may be withdrawn from the SBCR 104 continuously or semi-continuously while a fresh/active catalyst slurry 124 is continuously or semi-continuously added to the SBCR. The term semi-continuously here refers to an operation that is performed periodically; for example, removal or addition of 5% of the reactor catalyst slurry inventory every week.

The catalyst slurry 122 comprises the reactor bottoms fraction with partially deactivated catalyst in heavy oil and residual unconverted components of feed stream 101 and hydrocarbon products of the HDO reaction that are not vaporized under the SBCR operating conditions. The catalyst slurry 122 may be filtered to separate the catalyst and other solids from a filtrate. Various types of filter are known to persons skilled in the art and may be adapted to the present technology. In preferred embodiments, a pressure leaf filter system comprising a plurality of vertical or horizontal filter leaves is used. In such embodiments, at least two filter housings are employed with one in filtration service and the other in filter cake discharge and precoat deposit mode. Diatomaceous earth (DE) is a preferred pre-coat media and may be deposited by circulating a slurry of the DE in a clean oil through the filter leaves. When the pressure-drop across one housing exceeds a target value, the slurry is directed to the other filter housing with fresh precoat media.

The filtered catalyst may undergo regeneration, metal reclamation, or disposal. The filtrate is substantially free of the phosphorus and metal contaminants present in the feed stream 101 and may subsequently be subjected to unit operations such as distillation or extraction for separating the liquid phase HDO products from the heavy oil. Alternatively or in addition, with the feedstock phosphorus and metals removed, the filtrate may be subjected to hydroprocessing in a fixed-bed reactor system for removal of remaining oxygen, sulfur, and nitrogen heteroatoms according to prior art. Since the heavy oil has an initial boiling point greater than 650 F, and the liquid phase HDO product generally has a boiling point below 603 F (n-octadecane boiling point) distillation may be used for the separation. Various distillation systems, such as vacuum or steam distillation, are known to persons of ordinary skill in the art and well suited for this application.

Furthermore, since the heavy oil is mainly a naphthenic/aromatic hydrocarbon composition while the liquid phase HDO product is paraffinic, solvent extraction is another option. For example, heptane may be used to selectively extract the paraffins (liquid phase HDO product) out of the heavy oil. In embodiments, the extraction of the paraffin is performed without filtration of the catalyst, allowing the heavy oil slurry to be returned to the reactor with fresh/active catalyst slurry 124.

### EXAMPLES

### Example 1

An autoclave reactor was equipped with a catalyst basket for this experiment. The reactor included two separate tubes for addition of H2 and liquid feed, both entering the reactor through the bottom by the agitator blade. The reactor vent gas/vapors flowed through a condenser cooled with a water mixture controlled at 100 F.

The catalyst basket was loaded with 45 grams of a NiMo catalyst commercially supplied for ebullated bed resid hydrocracking operation. A heavy oil, PARATHERM HT, was added to the reactor, submerging the basket. The reactor was purged with hydrogen, heated to 640° F., and pressurized to 270 psig. After completion of catalyst sulfiding, a continuous feed of canola oil was subsequently commenced to the reactor at a rate of 1.5 mL/min with H2 flowing at 2.26 SLPM.

Reactor product was recovered continuously in the reactor vent condenser, with grab samples taken periodically during the run. Table I provides a summary of the slurry reactor product properties as sampled.

Stable reactor operation was established after Sample #3. As observed, the product samples had a total acid number (TAN) value less than 1 mg KOH/g. The cloud point values and hydrocarbon composition (mainly diesel/kero boiling range paraffins such as heptadecane and octadecane) are similar to values reported in the prior art for conventional fixed-bed hydrodeoxygenation reactor systems.

| Sample ID charged | Sample #2 | Sample #3 | Sample #4 |
|---|---|---|---|
| % of total volume charged to reactor | 45.6% | 72.4% | 100% |
| TAN, mg KOH/g | 1.177 | 0.649 | 0.638 |
| Cloud Pt, ° C. | 17.5 | 19.1 | 20.8 |
| C17 | 16.63 | 19.22 | 22.07 |
| C18 | 29.91 | 36.24 | 41.26 |
| C24+ | 6.31 | 4.68 | 3.31 |

After separation of water (reaction byproduct), the hydrocarbon product was weighed. A hydrocarbon yield value of 74% was thus calculated which compares to a stoichiometric yield value of about 85%.

### Table I. Results of the Example 1 FOG Conversion Experiment Example 2

The same autoclave reactor previously described in Example 1 was used for this experiment. However, for this experiment the catalyst basket was removed from the reactor and all other reactor internals described remained.

The reactor was loaded with about 240 g of a catalyst slurry comprising a presulfided and preactivated MoS2 catalyst with NiS as a promoter. The catalyst slurry material was composed of 9.8 wt % catalyst solid fines in a carrier VGO fluid, suggesting about 23.5 g of catalyst solids were charged. The slurry catalyst was prepared according to U.S. Pat. Nos. 8,703,637 and 8,802,586. The average particle size of the slurry catalyst was about 12 microns. The reactor was purged with hydrogen, heated to 650° F., and pressurized to 250 psig. A continuous feed of canola oil was charged to the reactor at a rate of 1.5 mL/min with H2 flowing at 3.39 SLPM.

As before, product was continuously recovered from the reactor vent condenser collection point with samples taken periodically throughout the run. The paraffinic product was gravimetrically separated from the water byproduct prior to completing the analyses. Table II summarizes the slurry reactor product properties from this experiment. For all product samples collected, TAN had a value less than 0.3 mg KOH/g and there was no detectable C24+ compounds, indicating close to complete conversion. On average, the cloud point of the product was 23.5° C. The substantial amount of nC17 present vs nC18 (reported as wt % concentration) indicates decarboxylation was favorable under these reaction conditions.

TABLE II
Results of Example 2 FOG conversion experiment

| Sample ID | Sample 1 | Sample 2 | Sample 3 | Sample 4 |
|---|---|---|---|---|
| TAN, mg KOH/g | 0.10 | 0.22 | 0.26 | 0.15 |
| Cloud Pt, ° C. | 22.7 | 23.5 | 23.7 | 23.9 |
| nC17 | 57.3 | 57.8 | 57.8 | 58.8 |
| nC18 | 27.5 | 30.1 | 30.6 | 29.8 |
| C24+ | 0 | 0 | 0 | 0 |

### Example 3

For this set of experiments, a different autoclave reactor was used. The reactor was 1 liter in volume and equipped with an agitator. The reactor was charged with 200 mL of the slurry catalyst described in the previous example. Choice white grease (a low-value lard feedstock) was used as reactor feed for the experiment. The contaminant profile of the Choice White Grease (CWG) feed is presented in Table III below under the heading Reactor Charge.

TABLE III
Results of Example 3 conversion experiment with
Choice White Grease showing contaminants detected
in reactor charge and product fractions

| Contaminants/impurities | Reactor | Reactor overhead | Reactor bottoms |
|---|---|---|---|
| (wppm) | Charge | product | fraction |
| Nitrogen | 287.5 | n.d. | 26.97 |
| Sulfur | 32.89 | n.d. | 67.88 |
| Calcium | 5.435 | n.d. | n.d. |
| Iron | 0.376 | n.d. | n.d. |
| Lithium | 0.154 | n.d. | n.d. |
| Magnesium | 1.574 | n.d. | n.d. |
| Molybdenum | n.d. | n.d. | 0.210 |
| Nickel | n.d. | n.d. | 0.385 |
| Phosphorus | 39.76 | n.d. | n.d. |
| Potassium | 11.26 | n.d. | n.d. |
| Sodium | 12.02 | n.d. | n.d. |

The reactor was purged with hydrogen and maintained under agitation (1200-1300 rpm) with H2 flow (5-6 MSCFH) at pressure of 600 psig and 640 F.

After maintaining slurry catalyst at the above target conditions, 665 g of CWG feed was fed to the reactor over a period of about 1 hr. The reactor was operated for another 8 hrs before cooldown and discharge. During the operating period, water byproduct was collected in a reactor vent condenser.

The discharged product was filtered and then distilled to obtain an overhead product and a bottoms fraction. The overhead product was analyzed by GC and found to be a C13-C20 paraffinic hydrocarbon comprising 17% nC15, 10.1% nC16, 44% nC17, and 21% nC18. This product had a cloud point of 19.8° C. and represented a yield of 69.5 wt %.

As observed in Table III, the overhead product is free of sulfur and nitrogen and well suited for isomerization over catalysts with low sulfur and nitrogen tolerance.

Furthermore, the bottoms fraction is substantially free of the contaminants in the CWG feedstock, suggesting that these contaminants were either converted into solid particulates or adsorbed onto the slurry catalyst, both of which were mostly filtered. As such, the slurry HDO method disclosed herein not only achieves hydroconversion of feedstock with relatively high phosphorus and metals into HDO product fractions suitable for use as diesel blendstock or for isomerization, but also provides a reactor bottoms fraction that has been substantially cleaned of contaminants for further processing, including hydroprocessing in fixed-bed reactor systems.

1. A method for hydroconversion of a feedstock comprising fats, oils, and greases (FOG) comprising
a. Introducing the feedstock to a reactor containing a catalyst slurried in a heavy oil
b. Maintaining the reactor a temperature, a pressure, liquid hourly space velocity (LHSV), and a hydrogen supply rate to achieve conversion of the feedstock to a hydrocarbon product
c. Removing from the reactor a vapor phase comprising the hydrocarbon product wherein
the temperature is between 630 and 750 F
the pressure is between 150 and 1,000 psig
the LHSV is between 0.2/h and 10/h
the hydrogen supply rate is between 3,000 and 15,000 SCF per bbl of feedstock and
the vapor phase is partially condensed to recover the hydrocarbon product.

2. The method of claim 1 wherein the feedstock comprises animal fats and plant-based oils with a combined phosphorus and metals content greater than 10 wppm.

3. The method of claim 1 wherein the feedstock comprises bio-oils from fast pyrolysis or hydrothermal liquefaction of lignocellulosic biomass.

4. The method of claim 1 wherein the catalyst comprises sulfided molybdenum.

5. The method of claim 1 wherein the catalyst is present in the heavy oil at a concertation between 1 wt % and 20 wt %.

6. The method of claim 1 wherein the heavy oil is a high temperature heat transfer fluid or vacuum gas oil.

7. The method of claim 1 wherein the hydrocarbon product comprises heptadecane and octadecane.

8. The method of claim 1 wherein the hydrocarbon product has a total acid number less than 1 mg KOH/g.

9. The method of claim 1 wherein the hydrocarbon product is isomerized to provide hydrocarbon fractions suitable for use as diesel and/or jet fuel.

10. The method of claim 1 wherein the reactor is a slurry bubble column reactor operating in the chum-turbulent regime wherein the hydrogen is supplied by a hydrogen-rich gas at a flow rate from about 7 cm/s to about 40 cm/s.

11. The method of claim 1 wherein the slurry is withdrawn from the reactor and filtered to provide a filtrate substantially free of the phosphorus and metals in the feedstock.

12. The method of claim 11 wherein in the filtrate is subjected to hydroprocessing in a fixed-bed reactor system for removal of remaining oxygen, sulfur, and nitrogen heteroatoms.
